(19) United States
(12) Patent Application Publication
(10) Pub. No.: US 2022/0236743 A1
(43) Pub. Date: Jul. 28, 2022

(54) POWER SUPPLY SYSTEM AND POWER SUPPLY DEVICE

(71) Applicants: Kawasaki Jukogyo Kabushiki Kaisha, Kobe-shi, Hyogo (JP); NAKANISHI METAL WORKS CO., LTD., Osaka-shi, Osaka (JP)

(72) Inventors: Eiji YOSHIKUWA, Kobe-shi, Hyogo (JP); Toshiyuki TSUJIMORI, Kobe-shi, Hyogo (JP); Hideshi YAMANE, Kobe-shi, Hyogo (JP); Shoichi MIYAO, Kobe-shi, Hyogo (JP); Yoshihiro OKAZAKI, Osaka-shi, Osaka (JP); Ryoichi KITAGUCHI, Nara-shi, Nara (JP); Yuichi OTSUJI, Matsubara-shi, Osaka (JP); Masayoshi HOSHI, Takatsuki-shi, Osaka (JP); Shigetomo MATSUI, Higashiosaka-shi, Osaka (JP); Kanji MATSUSHIMA, Kobe-shi, Hyogo (JP); Hiromu WAKAYAMA, Kobe-shi, Hyogo (JP)

(73) Assignees: Kawasaki Jukogyo Kabushiki Kaisha, Kobe-shi, Hyogo (JP); NAKANISHI METAL WORKS CO., LTD., Osaka-shi, Osaka (JP)

(21) Appl. No.: 17/612,569

(22) PCT Filed: May 21, 2020
(86) PCT No.: PCT/JP2020/020189

§ 371 Date: Nov. 19, 2021

(30) Foreign Application Priority Data
May 21, 2019 (JP) 2019-095311

(51) Int. Cl. G05D 1/02; H02J 7/00; B25J 5/00; B25J 19/00; B60L 53/57; B60L 53/35; B60L 53/66

(52) U.S. Cl. CPC G05D 1/0297; H02J 7/00032; H02J 7/0047; G05D 1/0217; B60L 53/66; B25J 19/005; B60L 53/57; B60L 53/35; B25J 5/00

(57) ABSTRACT

A power supply system includes: a robot including a power storage device; a movable power supply device; and a controller. The power supply device includes a first electrical connector which is electrically connectable to a second electrical connector of the robot and which is electrically connected to a power supply source via a wire, and the controller performs control for electrically connecting the first electrical connector and the second electrical connector and supplying power to the robot, on the basis of information about an amount of power stored in the power storage device.

### TECHNICAL FIELD

The present disclosure relates to a power supply system and a power supply device.

### BACKGROUND ART

In recent years, a work robot including a traveling device has been used in order to enable work in various places. For example, PTL 1 discloses a work robot including a moving mechanism and a work arm. The work robot of PTL 1 includes a power storage device, and performs work while consuming the power of the power storage device. When the amount of power remaining in the power storage device of the work robot becomes small, a power supply robot including a moving mechanism connects to the work robot to supply and charge the work robot with the power of a power storage device of the power supply robot.

### CITATION LIST

### Patent Literature

PTL 1: Japanese Laid-Open Patent Publication No. H06-133411

### SUMMARY OF INVENTION

### Technical Problem

The power supply robot of PTL 1 includes a larger power storage device than the power storage device of the work robot, but the storage capacity of the power storage device that can be mounted on the power supply robot has an upper limit. Therefore, when it is necessary to supply and charge work robots with power, the amount of power stored in the power storage device of the power supply robot may become insufficient. Furthermore, since it takes a long time to charge the power storage device of the power supply robot, the work robot cannot be supplied and charged with power during charging of the power supply robot in some cases.

Therefore, an object of the present disclosure is to provide a power supply system and a power supply device which enable stable power supply to a robot.

### Solution to Problem

In order to achieve the above object, a power supply system according to an aspect of the present disclosure includes: a robot including a power storage device; a movable power supply device; and a controller, the power supply device includes a first electrical connector that is electrically connectable to a second electrical connector of the robot and that is electrically connected to a power supply source via a wire, and the controller performs control for electrically connecting the first electrical connector and the second electrical connector and supplying power to the robot, on the basis of information about an amount of power stored in the power storage device.

A power supply device according to an aspect of the present disclosure is a movable power supply device including: a first electrical connector that is electrically connectable to a second electrical connector of a robot including a power storage device and that is electrically connected to a power supply source via a wire; and a controller that performs control for supplying power to the robot via the first electrical connector, on the basis of information about an amount of power stored in the power storage device.

### Advantageous Effects of Invention

According to the technology of the present disclosure, it is possible to stably supply power to a robot.

### BRIEF DESCRIPTION OF DRAWINGS

FIG. 1 is a plan view showing an example of the configuration of a power supply system according to an embodiment.

FIG. 2 is a side view showing an example of the configuration of a robot according to the embodiment.

FIG. 3 is a side view showing an example of the configuration of a power supply device according to the embodiment.

FIG. 4 is a block diagram showing an example of the configuration of the robot according to the embodiment.

FIG. 5 is a block diagram showing an example of the functional configuration of a robot controller according to the embodiment.

FIG. 6 is a block diagram showing an example of the configuration of the power supply device according to the embodiment.

FIG. 7 is a plan view showing an example of a connection state between the robot and the power supply device in FIG. 1.

FIG. 8 is a block diagram showing an example of the functional configuration of a power supply controller of the power supply device according to the embodiment.

FIG. 9 is a flowchart showing an example of a first operation of the power supply system according to the embodiment.

FIG. 10 is a plan view showing an example of arrangement of robots and one power supply device.

FIG. 11 is a flowchart showing an example of a second operation of the power supply system according to the embodiment.

FIG. 12 is a flowchart showing an example of a third operation of the power supply system according to the embodiment.

FIG. 13 is a plan view showing an example of arrangement of robots and power supply devices.

FIG. 14 is a flowchart showing an example of a fourth operation of the power supply system according to the embodiment.

FIG. 15 is a plan view showing an example of the configuration of a power supply system according to Modification 1.

FIG. 16 is a side view showing an example of a connection state between a robot and a power supply device according to Modification 1.

FIG. 17 is a plan view showing an example of the configuration of a power supply system according to Modification 2.

FIG. 18 is a side view showing an example of a connection state between a robot and a power supply device according to Modification 2.

FIG. 19 is a plan view showing an example of the configuration of a power supply system according to Modification 3.

FIG. 20 is a block diagram showing an example of the configuration of a power supply device according to Modification 3.

FIG. 21 is a block diagram showing an example of the functional configuration of a power supply controller of the power supply device according to Modification 3.

FIG. 22 is a block diagram showing an example of the configuration of a management apparatus and the functional configuration of a management controller according to Modification 3.

### DESCRIPTION OF EMBODIMENTS

### Embodiments

Hereinafter, embodiments of the present disclosure will be described with reference to the drawings. The embodiments described below are all comprehensive or specific examples. In addition, among the components in the following embodiments, the components not described in the independent claims which represent broadest concepts are described as optional components. Moreover, each figure in the accompanying drawings is a schematic view and is not necessarily exactly illustrated. Furthermore, in each figure, substantially the same components are designated by the same reference signs, and the repetitive description thereof may be omitted or simplified.

<Configuration of Power Supply System 1>

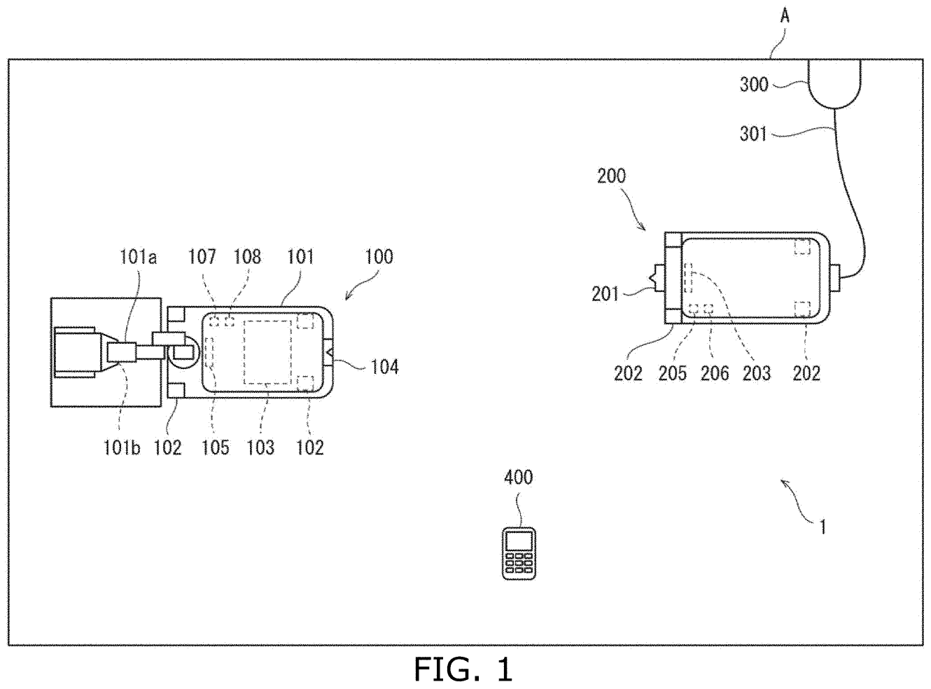

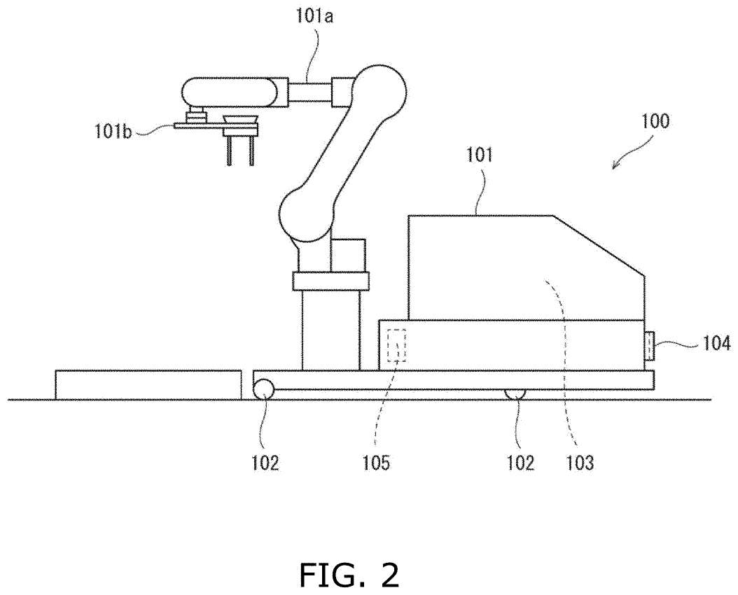

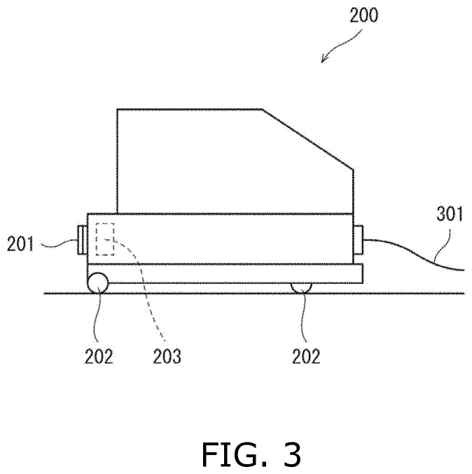

FIG. 1 is a plan view showing an example of the configuration of a power supply system 1 according to an embodiment. FIG. 2 is a side view showing an example of the configuration of a robot 100 according to the embodiment. FIG. 3 is a side view showing an example of the configuration of a power supply device 200 according to the embodiment. As shown in FIG. 1 to FIG. 3, the power supply system 1 includes one or more robots 100, one or more power supply devices 200, and a power supply source 300.

Each robot 100 includes a robot main body 101 and a traveling device 102. The traveling device 102 travels on a floor surface or the like to move the robot 100 to a desired location. The traveling device 102 includes traveling means, such as wheels or crawlers (also referred to as “caterpillars (registered trademark)”). The robot main body 101 performs a desired operation, such as work, at a desired location. For example, the robot main body 101 includes one or more arms 101a and a manipulator 101b at the tip of each arm 101a, and performs work using the arm 101a and the manipulator 101b. The manipulator 101b can hold an object, for example, by grasping, sucking, or scooping up the object. In the present embodiment, the robot 100 is a work robot, but is not limited thereto and may be any robot.

The robot 100 also includes a power storage device 103, a terminal 104, and a robot controller 105. The robot controller 105 controls the operation of the entire robot 100, such as the robot main body 101 and the traveling device 102. The power storage device 103 includes a storage battery, such as a secondary battery, and constitutes a power source of the robot 100. The secondary battery is a battery capable of charging and discharging power. Examples of the secondary battery include lead storage batteries, lithium-ion secondary batteries, nickel-hydrogen storage batteries, and nickel-cadmium storage batteries. The terminal 104 is physically and electrically connectable to a terminal 201 of the power supply device 200, and receives power supplied from the power supply device 200. The power storage device 103 can store the power supplied via the terminal 104. The terminal 104 is an example of a second electrical connector, and the terminal 201 is an example of a first electrical connector.

The power supply source 300 is a facility which is physically and electrically connected to each power supply device 200 by a power line 301 and which supplies DC power or AC power to the power supply device 200 via the power line 301. For example, the power supply source 300 is arranged at a work place A, for example, in a factory or a warehouse where the robot 100 is arranged. The power supply source 300 receives power supplied from a power system, such as a commercial power supply, and sends the supplied power to the power supply device 200. The power supply source 300 may include a power storage device which is not shown, and may supply power temporarily stored in this power storage device, to the power supply device 200, or may directly supply the power from the power system to the power supply device 200.

Each power supply device 200 includes the terminal 201, a traveling device 202, and a power supply controller 203. The traveling device 202 travels on a floor surface or the like to move the power supply device 200 to a target robot 100. The traveling device 202 includes traveling means, such as wheels or crawlers. The terminal 201 is electrically connected to the power line 301 and thereby electrically connected to the power supply source 300. The terminal 201 is configured to be physically and electrically connected to the terminal 104 of the robot 100. The power supply controller 203 controls the operation of the entire power supply device 200, and controls, for example, traveling of the robot 100, power supply to the robot 100 via the terminal 201, etc. The power supply controller 203 is an example of a controller.

<Configuration of Robot 100>

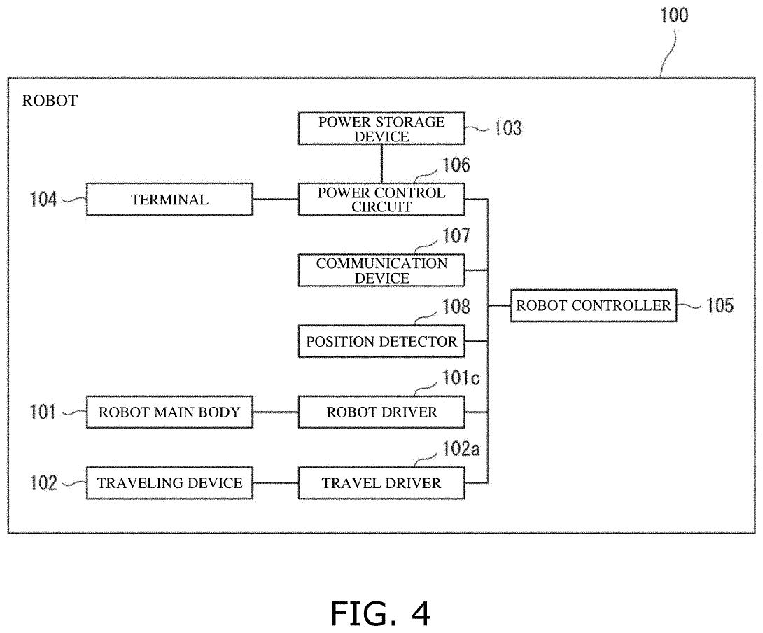

FIG. 4 is a block diagram showing an example of the configuration of the robot 100 according to the embodiment. As shown in FIG. 1, FIG. 2, and FIG. 4, the robot 100 includes the robot main body 101, the traveling device 102, the power storage device 103, the terminal 104, the robot controller 105, a power control circuit 106, a communication device 107, and a position detector 108 as components. Not all of these components are essential.

The robot main body 101 includes a robot driver 101c, and the robot driver 101c includes drivers, which are, for example, electric motors, such as servomotors, arranged on joints of the arm 101a and the manipulator 101b or the like. The robot driver 101c operates the joints of the arm 101a, the manipulator 101b, etc., under the control of the robot controller 105. In the present embodiment, the arm 101a is a vertical articulated arm having links and joints which sequentially connect the links, but is not limited thereto.

The traveling device 102 includes a travel driver 102a, and the travel driver 102a includes an electric motor which drives the traveling means of the traveling device 102, an electric motor which changes the traveling direction of the traveling means, etc. The travel driver 102a causes the traveling device 102 to travel in a desired direction under the control of the robot controller 105.

The components such as the power storage device 103, the terminal 104, the robot controller 105, the power control circuit 106, the communication device 107, the position detector 108, the robot driver 101c, and the travel driver 102a are electrically connected to each other. The connection relationship between each component is not limited to the relationship in FIG. 4. The connection between each component may be any wired or wireless connection.

The configuration of the power storage device 103 is as described above.

The terminal 104 is fixed to the robot main body 101. In the present embodiment, the terminal 104 is fixed to a side surface of a rear portion, of the robot main body 101, opposite to the arm 101a, although not limited thereto.

The power control circuit 106 supplies the power of the power storage device 103 to the other components of the robot 100 under the control of the robot controller 105. In addition, the power control circuit 106 supplies the power supplied to the terminal 104, to the power storage device 103 and the other components under the control of the robot controller 105. The power control circuit 106 may include a charging circuit and/or a discharging circuit, and may further include an AC-DC conversion circuit and/or a DC-AC conversion circuit and perform power conversion.

The communication device 107 includes a wireless communication circuit and wirelessly communicates with the power supply device 200, etc. The communication device 107 may communicate with an individual power supply device 200, or may communicate with power supply devices 200 and transmit information thereto all at once. For example, the communication device 107 transmits information about the amount of power stored in the power storage device 103 and position information of the robot 100 to the power supply device 200 under the control of the robot controller 105.

The information about the amount of power stored in the power storage device 103 may include information indicating the level of the amount of power stored in the power storage device 103, such as the amount of power remaining in the storage battery, the SOC (State Of Charge), the DOD (Depth Of Discharge), and the voltage of the storage battery, and the like, may include information, such as the voltage value and the current value of the power storage device 103, for detecting the level of the amount of power stored, and may include a command for requesting or instructing power supply to the power storage device 103. The information about the amount of power stored in the power storage device 103 may include identification information, such as an ID, of the robot 100 on which the power storage device 103 is mounted.

Moreover, the communication device 107 may wirelessly communicate with a device other than the power supply device 200. For example, the communication device 107 may communicate with a terminal device 400 which transmits a command to the robot 100, acquire information such as the work place and work contents of the robot 100 from the terminal device 400, and output the information to the robot controller 105.

For the wireless communication used by the communication device 107, a wireless LAN (Local Area Network), such as Wi-Fi (registered trademark) (Wireless Fidelity), may be applied, short-range wireless communication, such as Bluetooth (registered trademark) and ZigBee (registered trademark), may be applied, or any other wireless communication may be applied.

The position detector 108 is a device which detects the position of the robot 100, and outputs information on the detected position of the robot 100 to the robot controller 105. The position detector 108 includes a positioning device, such as a GPS (Global Positioning System) receiver and an IMU (Inertial Measurement Unit).

For example, the position detector 108 may acquire the three-dimensional coordinates of the robot 100 on Earth via the GPS receiver and output the three-dimensional coordinates to the robot controller 105. The position detector 108 may acquire the measured values of a three-axis acceleration sensor and a three-axis angular velocity sensor included in the IMU and output the measured values to the robot controller 105. The position detector 108 may acquire the three-dimensional coordinates of the robot 100 and the measured values of the IMU and output the three-dimensional coordinates and the measured values to the robot controller 105. It is possible to calculate the moving direction, the moving distance, and the orientation of the robot 100 by using the measured values of the IMU. In the present embodiment, the robot controller 105 detects the position and the orientation of the robot 100 by using the information acquired from the position detector 108, but the position detector 108 may detect the position and the orientation of the robot 100. The position detector 108 may acquire the position of the robot 100 from an external device outside the robot 100, which manages or measures the positions of the robot 100 and the like.

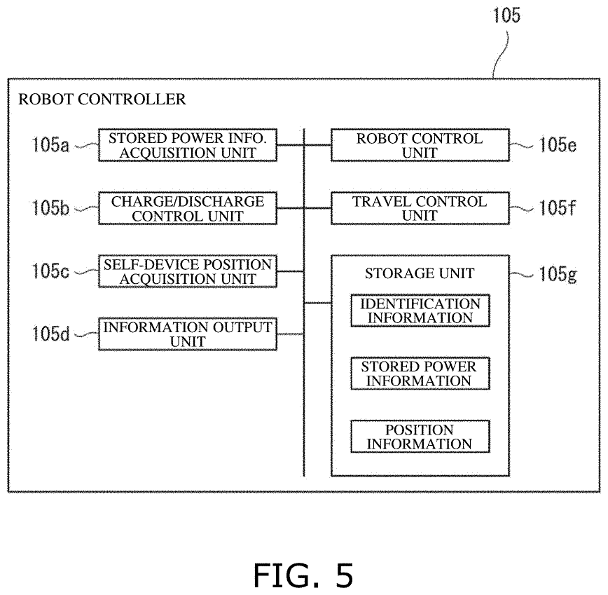

The configuration of the robot controller 105 will be described. FIG. 5 is a block diagram showing an example of the functional configuration of the robot controller 105 according to the embodiment. As shown in FIG. 5, the robot controller 105 includes a stored power information acquisition unit 105a, a charge/discharge control unit 105b, a self-device position acquisition unit 105c, an information output unit 105d, a robot control unit 105e, a travel control unit 105f, and a storage unit 105g as functional components. Not all of these functional components are essential.

The functions of the components such as the stored power information acquisition unit 105a, the charge/discharge control unit 105b, the self-device position acquisition unit 105c, the information output unit 105d, the robot control unit 105e, and the travel control unit 105f may be realized by a computer system (not shown) which includes a processor, such as a CPU (Central Processing Unit), a volatile memory, such as a RAM (Random Access Memory), a non-volatile memory, such as a ROM (Read-Only Memory), etc. Some or all of the functions of the above components may be realized by the CPU using the RAM as a work area to execute a program recorded in the ROM. Some or all of the functions of the above components may be realized by the above computer system, may be realized by a dedicated hardware circuit, such as an electronic circuit or an integrated circuit, or may be realized by a combination of the above computer system and the above hardware circuit.

The storage unit 105g can store therein various kinds of information and allows the stored information to be read. The storage unit 105g is realized by a storage device, such as a semiconductor memory such as a volatile memory and a non-volatile memory, a hard disk, and an SSD (Solid State Drive). The storage unit 105g stores therein identification information of the robot 100, stored power information of the power storage device 103, position information of the robot 100, etc. The storage unit 105g may store therein a program to be executed by each component of the robot controller 105.

The stored power information of the power storage device 103 includes information about the amount of power stored in the power storage device 103. The stored power information may include not only information about the present amount of power stored in the power storage device 103 but also information about the past amount of power stored in the power storage device 103, together with the detection times thereof. Moreover, the stored power information may include a threshold for the level of the amount of power stored at which charging of the power storage device 103 becomes necessary.

The position information of the robot 100 includes information on the position and the orientation of the robot 100 and the like. The position information may include not only the present position information of the robot 100 but also the past position information of the robot 100 together with the detection times thereof. Moreover, the position information may include information on a map of the place where the robot 100 works, or information on the position and the orientation of the robot 100 and the like associated with the map.

The stored power information acquisition unit 105a acquires the level of the amount of power stored in the power storage device 103. Specifically, the stored power information acquisition unit 105a acquires the voltage value, the current value, etc., of the power storage device 103 via the power control circuit 106, detects the level of the amount of power stored, such as SOC, by using the voltage value, current value, etc., and stores the level in the storage unit 105g.

The charge/discharge control unit 105b controls the power control circuit 106 and controls power supply from the power storage device 103 to each component of the robot 100. Furthermore, the charge/discharge control unit 105b controls the power control circuit 106 and controls power supply from the terminal 104 to the power storage device 103 and each component of the robot 100.

The self-device position acquisition unit 105c detects the position and the orientation of the robot 100 by using the information acquired from the position detector 108, and stores the position and the orientation of the robot 100 in the storage unit 105g.

The information output unit 105d transmits the information about the amount of power stored in the power storage device 103, to the power supply device 200 or the like via the communication device 107. For example, the information output unit 105d may output the information about the amount of power stored in the power storage device 103 when the level of the present amount of power stored in the power storage device 103 becomes equal to or lower than the threshold, or may periodically output the information about the amount of power stored in the power storage device 103.

The robot control unit 105e controls the operation of the robot main body 101, specifically the operation of the arm 101a and the manipulator 101b, by controlling the robot driver 101c. The robot control unit 105e performs control according to a program corresponding to a preset command or a command acquired via the communication device 107.

The travel control unit 105f controls the operation of the traveling device 102 by controlling the travel driver 102a. The travel control unit 105f moves the robot 100 to a preset work point or a work point acquired via the communication device 107, by using the position information of the robot 100.

<Configuration of Power Supply Device 200>

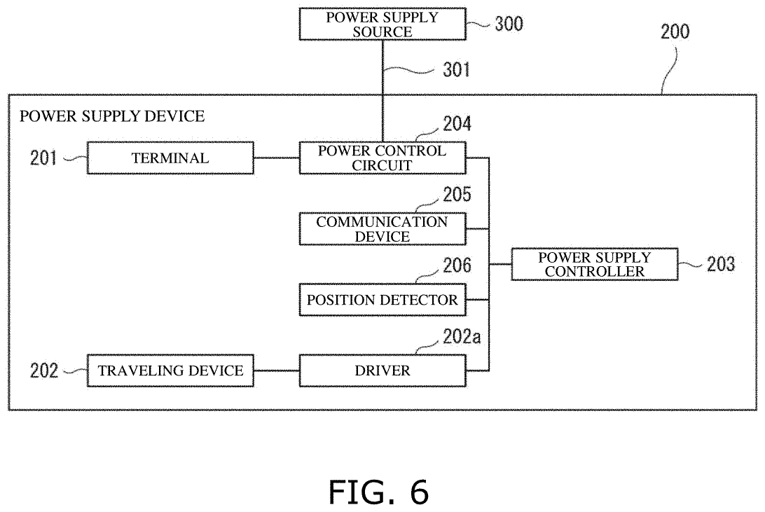

FIG. 6 is a block diagram showing an example of the configuration of the power supply device 200 according to the embodiment. As shown in FIG. 1, FIG. 3, and FIG. 6, the power supply device 200 includes the terminal 201, the traveling device 202, the power supply controller 203, a power control circuit 204, a communication device 205, and a position detector 206 as components. Not all of these components are essential.

The traveling device 202 includes a driver 202a, and the driver 202a includes an electric motor which drives the traveling means of the traveling device 202, an electric motor which changes the traveling direction of the traveling means, etc. The driver 202a causes the traveling device 202 to travel in a desired direction under the control of the power supply controller 203.

The components such as the terminal 201, the power supply controller 203, the power control circuit 204, the communication device 205, the position detector 206, and the driver 202a are electrically connected to each other. The connection relationship between each component is not limited to the relationship in FIG. 6. The connection between each component may be any wired or wireless connection.

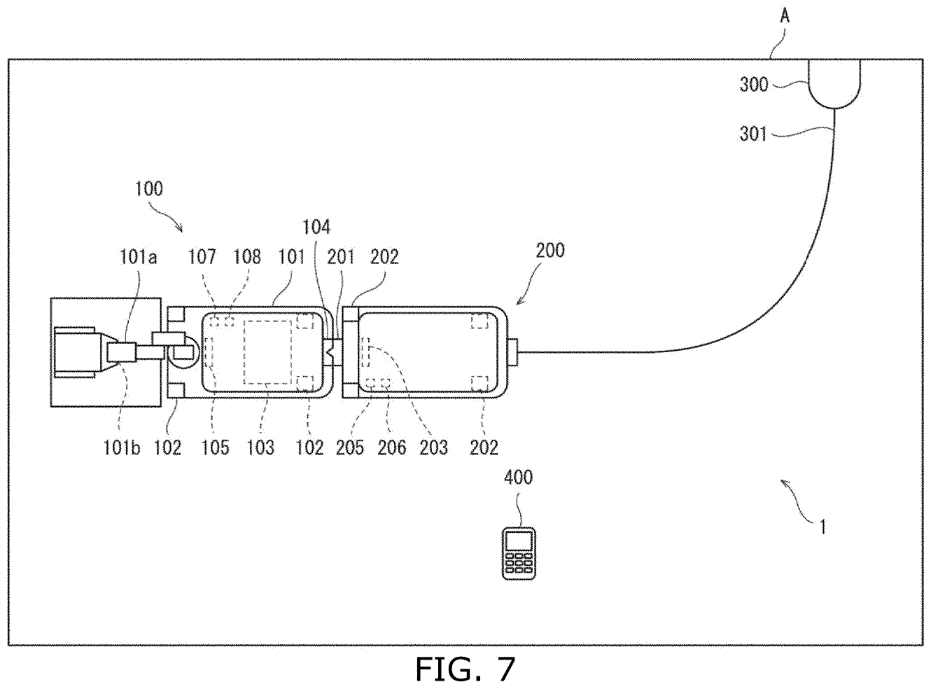

The terminal 201 is fixed to the power supply device 200. In the present embodiment, the terminal 201 is fixed to a side surface of a front portion in the forward direction of the power supply device 200, although not limited thereto. Therefore, as shown in FIG. 7, the power supply device 200 can physically and electrically connect the terminal 201 at the front portion thereof to the terminal 104 at the rear portion of the robot 100 by moving forward toward the rear portion of the robot 100. FIG. 7 is a plan view showing an example of a connection state between the robot 100 and the power supply device 200 in FIG. 1. FIG. 7 shows that the robot 100 and the power supply device 200 are connected to each other only via the terminals 104 and 201, but the connection between the robot 100 and the power supply device 200 is not limited thereto. For example, the robot 100 and the power supply device 200 may be configured to engage or fit other parts with each other, or may include guides for guiding the connection.

The power control circuit 204 supplies the power supplied from the power supply source 300, to each component of the power supply device 200 under the control of the power supply controller 203. In addition, the power control circuit 204 supplies the power supplied from the power supply source 300, to the terminal 104 of the robot 100 connected to the terminal 201, under the control of the power supply controller 203. The power control circuit 204 may include an AC-DC conversion circuit and/or a DC-AC conversion circuit or the like and perform power conversion.

The communication device 205 includes a wireless communication circuit and wirelessly communicates with the communication device 107 of the robot 100, etc. The wireless communication used by the communication device 205 is the same as that by the communication device 107. The communication device 205 may communicate with an individual robot 100, or may communicate with robots 100. The communication device 205 receives, from the robot 100, the information about the amount of power stored in the power storage device 103 thereof, the position information of the robot 100, etc.

Moreover, the communication device 205 may wirelessly communicate with a device other than the robot 100. For example, the communication device 205 may communicate with the communication device 205 of another power supply device 200. For example, when one robot 100 transmits, to power supply devices 200, a command for requesting or instructing power supply, each power supply device 200 may transmit the position information of the power supply device 200 or the distance between the power supply device 200 and the robot 100 to the other power supply devices 200. Then, each power supply device 200 may determine to supply power to the robot 100 when the distance from the power supply device 200 to the robot 100 is the shortest as compared to those of the other power supply devices 200. Accordingly, efficient power supply to the robot 100 is enabled.

Alternatively, when one power supply device 200 receives a command for requesting or instructing power supply from robots 100, the power supply device 200 may determine the robot 100 whose distance from the power supply device 200 is the shortest, as a power supply target. Then, the power supply device 200 may transmit the identification information of the robot 100 that is the power supply target, to the other power supply devices 200. Accordingly, redundancy of power supply devices 200 that supply power to one robot 100 is suppressed.

The position detector 206 is a device which detects the position of the power supply device 200, and outputs information on the detected position of the power supply device 200 to the power supply controller 203. The position detector 206 includes a positioning device, such as a GPS receiver and an IMU. In the present embodiment, the power supply controller 203 detects the position and the orientation of the power supply device 200 by using the information acquired from the position detector 206, but the position detector 206 may detect the position and the orientation of the power supply device 200. The position detector 206 may acquire the position of the power supply device 200 from an external device outside the power supply device 200, which manages or measures the positions of the power supply device 200 and the like.

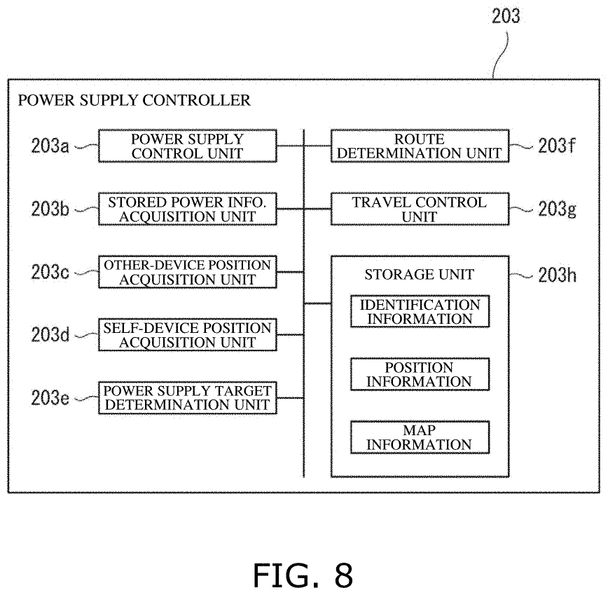

The configuration of the power supply controller 203 will be described. FIG. 8 is a block diagram showing an example of the functional configuration of the power supply controller 203 of the power supply device 200 according to the embodiment. As shown in FIG. 8, the power supply controller 203 includes a power supply control unit 203a, a stored power information acquisition unit 203b, an other-device position acquisition unit 203c, a self-device position acquisition unit 203d, a power supply target determination unit 203e, a route determination unit 203f, a travel control unit 203g, and a storage unit 203h as functional components. Not all of these functional components are essential.

The functions of the components such as the power supply control unit 203a, the stored power information acquisition unit 203b, the other-device position acquisition unit 203c, the self-device position acquisition unit 203d, the power supply target determination unit 203e, the route determination unit 203f, and the travel control unit 203g may be realized by a computer system which includes a processor, such as a CPU, a volatile memory, such as a RAM, a non-volatile memory, such as a ROM, etc. Some or all of the functions of the above components may be realized by the above computer system, may be realized by a dedicated hardware circuit, such as an electronic circuit or an integrated circuit, or may be realized by a combination of the above computer system and the above hardware circuit.

The storage unit 203h can store therein various kinds of information and allows the stored information to be read. The storage unit 203h is realized by a storage device, such as a semiconductor memory such as a volatile memory and a non-volatile memory, a hard disk, and an SSD. The storage unit 203h stores therein identification information of the power supply device 200, position information of the power supply device 200, map information, etc. The storage unit 203h may store therein a program to be executed by each component of the power supply controller 203.

The position information of the power supply device 200 includes information on the position and the orientation of the power supply device 200 and the like. The position information may include not only the present position information of the power supply device 200 but also the past position information of the power supply device 200 together with the detection times thereof.

The map information includes information on a map of the place where the power supply device 200 is arranged. For example, the map may be a map of an area where one power supply device 200 can supply power, or may be a map including the entire area where power supply devices 200 including this power supply device 200 can supply power.

The power supply control unit 203a detects the electrical connection between the terminal 201 and the terminal 104 via the power control circuit 204 and controls the power control circuit 204 to supply the power of the power supply source 300 to the robot 100. The power supply control unit 203a may acquire the level of the amount of power stored in the power storage device 103 of the robot 100, by acquiring the voltage value, the current value, etc., of the power storage device 103 via the terminal 201 and the power control circuit 204, or may acquire the level of the amount of power stored in the power storage device 103, from the stored power information acquisition unit 203b. The power supply control unit 203a controls power supply on the basis of the level of the amount of power stored in the power storage device 103.

The stored power information acquisition unit 203b acquires the information about the amount of power stored in the power storage device 103 from the robot 100 or the like via the communication device 205.

The other-device position acquisition unit 203c acquires the identification information and the position information of the robot 100 from the robot 100 or the like via the communication device 205. The other-device position acquisition unit 203c may store the identification information and the position information of the robot 100 in the storage unit 203h in association with each other.

The other-device position acquisition unit 203c may acquire identification information and position information of another power supply device 200 from said another power supply device 200 or the like via the communication device 205. Furthermore, the other-device position acquisition unit 203c may store the identification information and the position information of the other power supply device 200 in the storage unit 203h in association with each other.

The self-device position acquisition unit 203d detects the position and the orientation of the power supply device 200 by using the information acquired from the position detector 206, and stores the position and the orientation of the power supply device 200 in the storage unit 203h.

The power supply target determination unit 203e acquires the information about the amount of power stored in the power storage device 103 of the robot 100, from the stored power information acquisition unit 203b or the like, and determines whether to perform power supply to the robot 100. For example, the power supply target determination unit 203e may determine execution of power supply to the robot 100 whose level of the amount of power stored in the power storage device 103 is equal to or lower than a threshold. Alternatively, when the acquired information includes a command for requesting or instructing power supply, the power supply target determination unit 203e may determine power supply to the robot 100 that has transmitted this command.

Moreover, when the power supply target determination unit 203e acquires information about the amounts of power stored in robots 100 that may become a power supply target, the power supply target determination unit 203e may determine a robot 100 as a power supply target on the basis of the distance between each robot 100 and the power supply device 200, the level of the amount of power stored in each robot 100, and/or the distance between each robot 100 and another power supply device 200, or the like. The information about the amount of power stored in a power supply target is information about an amount of power stored including the need to supply power to the power storage device 103 of the robot 100, and may include information that the level of the amount of power stored in the power storage device 103 is equal to or lower than the threshold, and/or a command for requesting or instructing power supply to the power storage device 103, or the like.

For example, the power supply target determination unit 203e extracts the robots 100 located in the area where the power supply device 200 can supply power, from the position of each robot 100, and determines a robot 100 as a power supply target from among the extracted robots 100. For example, the area where the power supply device 200 can supply power may be an area that is defined by the length of the power line 301 and in which the power supply device 200 is movable. The area where power can be supplied is stored in advance in the storage unit 203h in association with the map information. The power supply target determination unit 203e may determine a robot 100 as a power supply target from among all the robots 100 from which the information about the amount of power stored in a power supply target has been received, without extracting the robots 100 located in the area where the power supply device 200 can supply power.

In a first determination method, the power supply target determination unit 203e may calculate the distance between each robot 100 and the power supply device 200 from the position of each robot 100 and the position of the power supply device 200, and determine the robot 100 having the shortest distance as a power supply target.

In a second determination method, the power supply target determination unit 203e may determine the robot 100 having the lowest level of the amount of power stored therein among the respective robots 100, as a power supply target.

In a third determination method, the power supply target determination unit 203e may calculate the distance between each robot 100 and each power supply device 200 from the position of each robot 100 and the position of each of all the power supply devices 200. Furthermore, the power supply target determination unit 203e may determine the robot 100 having the shortest distance from the power supply device 200 including this power supply target determination unit 203e as compared to the other power supply devices 200, as a power supply target.

Alternatively, the power supply target determination unit 203e may determine a robot 100 as a power supply target from among the robots 100 determined by at least two determination methods out of the first to third determination methods. That is, the power supply target determination unit 203e may combine and use at least two of the first to third determination methods. For example, when the power supply target determination unit 203e determines two or more robots 100 as power supply targets by using one of the first to third determination methods, the power supply target determination unit 203e may narrow down the robots 100 as power supply targets by using another determination method.

The route determination unit 203f determines a route for moving the power supply device 200 to the robot 100 determined by the power supply target determination unit 203e. Specifically, the route determination unit 203f acquires the position and the orientation of the robot 100 determined by the power supply target determination unit 203e, the position and the orientation of the power supply device 200, and the map information stored in the storage unit 203h. The route determination unit 203f identifies the relationship in position and orientation between the terminal 104 of the robot 100 and the terminal 201 of the power supply device 200 by using the acquired information. The route determination unit 203f determines a travel route of the power supply device 200 for connecting the terminal 201 to the terminal 104 on the basis of the above relationship and the map information. The travel route includes the position of the route and may further include the traveling direction of the power supply device 200 on the route. The route determination unit 203f outputs information on the determined travel route to the travel control unit 203g.

The travel control unit 203g controls the operation of the traveling device 202 by controlling the driver 202a. The travel control unit 203g causes the power supply device 200 to travel to a target robot 100 according to the travel route acquired from the route determination unit 203f, to connect the terminal 201 to the terminal 104. In addition, the travel control unit 203g may move the power supply device 200 to a predetermined location, such as a standby location, after charging of the power storage device 103 of the robot 100 is completed. The travel route to the predetermined location may be a travel route opposite to the above travel route, or may be determined by the route determination unit 203f on the basis of the position and the orientation of the power supply device 200 and the position of the predetermined location. Alternatively, when the travel control unit 203g acquires, from the route determination unit 203f, a travel route to the robot 100 to which power is to be supplied next, the travel control unit 203g may cause the power supply device 200 to travel according to this travel route.

<First Operation of Power Supply System 1>

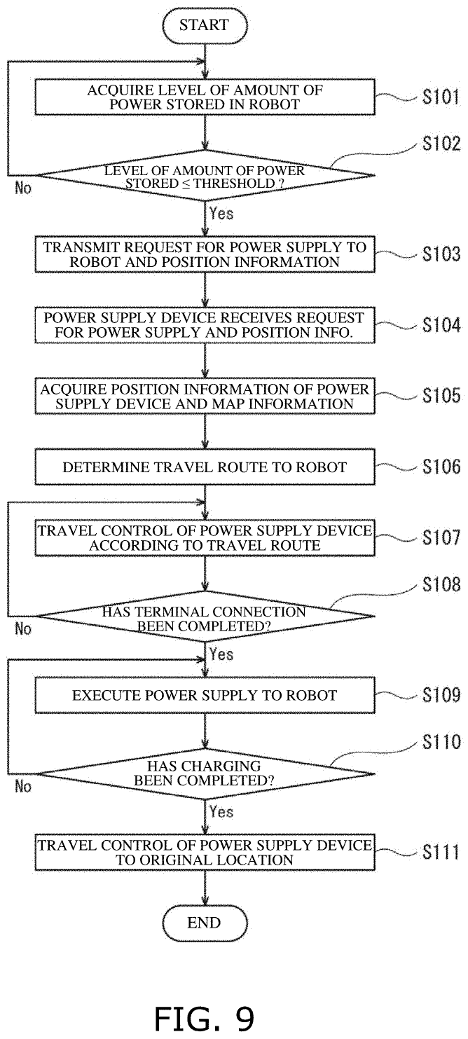

A first operation of the power supply system 1 according to the embodiment will be described. The first operation is an example of the operation of the power supply system 1 in case that one robot 100 and one power supply device 200 exist in the work place of the robot 100. FIG. 9 is a flowchart showing an example of the first operation of the power supply system 1 according to the embodiment.

As shown in FIG. 1 and FIG. 9, the robot controller 105 of the robot 100 acquires the level of the amount of power stored, such as the SOC, of the power storage device 103 (step S101).

Next, the robot controller 105 determines whether the level of the amount of power stored is equal to or lower than a threshold (step S102). If the level of the amount of power stored is equal to or lower than the threshold (Yes in step S102), the robot controller 105 proceeds to step S103, and if the level of the amount of power stored is higher than the threshold (No in step S102), the robot controller 105 returns to step S101. In step S103, the robot controller 105 transmits information about the amount of power stored including a request for power supply to the robot 100, and the position information of the robot 100 to the power supply device 200.

Next, the power supply controller 203 of the power supply device 200 receives the above information (step S104). Furthermore, the power supply controller 203 acquires the position information of the power supply device 200 and the map information of the work place A which is a place where the power supply device 200 and the robot 100 are arranged, from the storage unit 203h (step S105). The power supply controller 203 may acquire the position information of the power supply device 200 from the position detector 206.

Next, the power supply controller 203 determines a travel route from the power supply device 200 to the robot 100 by using the position information of the robot 100, the position information of the power supply device 200, and the map information (step S106). The travel route is a travel route until the power supply device 200 travels to the robot 100 and connects the terminal 201 of the power supply device 200 to the terminal 104 of the robot 100.

Next, the power supply controller 203 controls the driver 202a to cause the power supply device 200 to travel according to the determined travel route and connect the terminal 201 to the terminal 104 of the robot 100 (step S107).

Next, the power supply controller 203 determines whether the connection of the terminal 201 to the terminal 104 of the robot 100 has been completed to obtain an energized state therebetween (step S108). If the connection has been completed (Yes in step S108), the power supply controller 203 proceeds to step S109. If the connection has not been completed (No in step S108), the power supply controller 203 returns to step S107.

In step S109, the power supply controller 203 executes power supply to the robot 100. In step S110, the power supply controller 203 determines whether the charging of the power storage device 103 of the robot 100 has been completed. A state where the charging of the power storage device 103 has been completed may be a fully charged state, or may be a state where the level of the amount of power stored is equal to or higher than a threshold. The threshold may be higher than the threshold in step S102. In addition, while receiving power from the power supply device 200, the robot 100 can continue operations, such as work, by using the power of the power storage device 103 or the power supplied from the power supply device 200.

If the charging has been completed (Yes in step S110), the power supply controller 203 proceeds to step S111. If the charging has not been completed (No in step S110), the power supply controller 203 returns to step S109. In step S111, the power supply controller 203 performs control such that the power supply device 200 is moved to disconnect the terminal 201 and the terminal 104 and is caused to travel to the original location. The original location is the location before the start of travel for power supply to the robot 100, and may be, for example, a determined standby location.

By executing the processes in steps S101 to S111, the power supply system 1 can charge the power storage device 103 of the robot 100 when needed, while causing the robot 100 to continue working. In addition, since the robot 100 is connected to the power supply device 200 only while being charged, the influence of the power line 301 of the power supply device 200 on the work and movement of the robot 100 is suppressed. Moreover, since the power supply device 200 uses the power of the power supply source 300, power can be stably supplied to the robot 100 without any restriction on the amount of power supplied.

<Second Operation of Power Supply System 1>

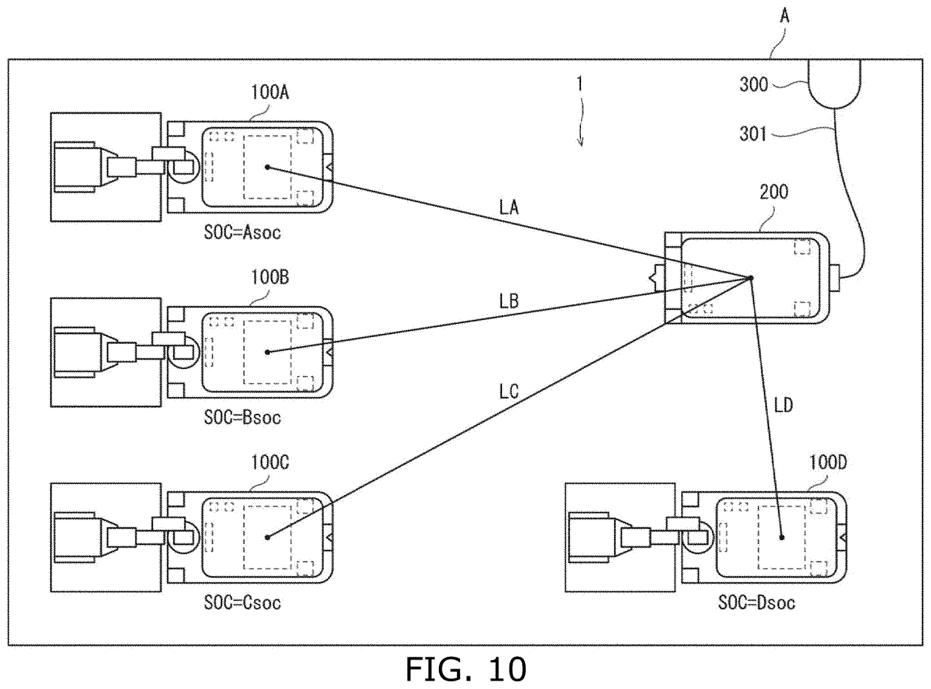

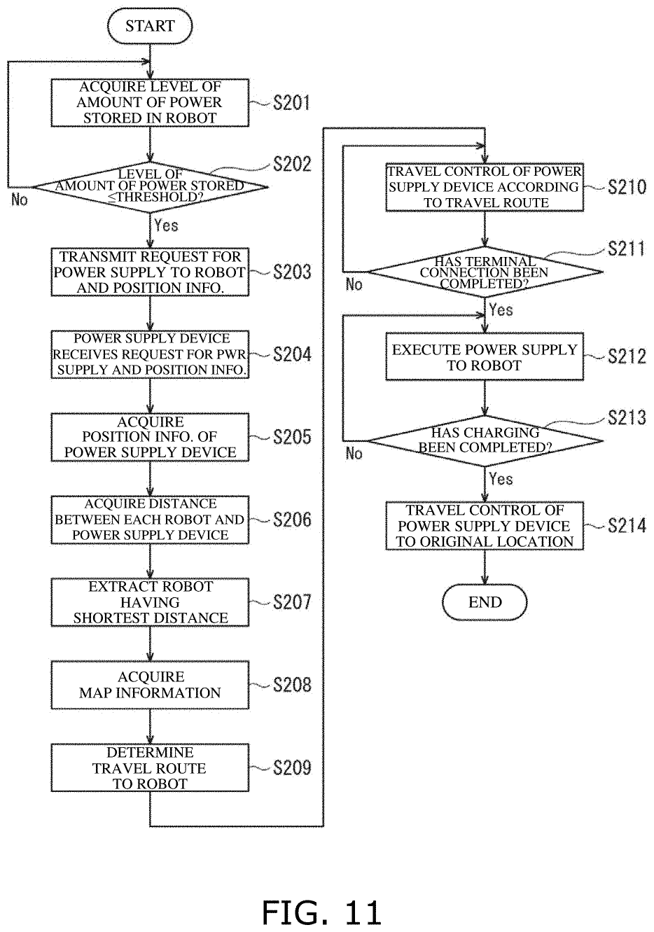

A second operation of the power supply system 1 according to the embodiment will be described. The second operation is an example of the operation of the power supply system 1 in case that robots 100 and one power supply device 200 exist in the work place of the robot 100. In the following, the second operation will be described for an example shown in FIG. 10. FIG. 10 is a plan view showing an example of arrangement of robots 100 (hereinafter, also referred to as “robots 100A to 100D”) and one power supply device 200. FIG. 11 is a flowchart showing an example of the second operation of the power supply system 1 according to the embodiment.

As shown in FIG. 10 and FIG. 11, the robot controller 105 of each of the robots 100A to 100D executes processes in steps S201 to S203 in the same manner as steps S101 to S103 of the first operation. In this example, in step S203, each of all of the robots 100A to 100D transmits information on the amount of power stored including a request for power supply to the robot, and the position information of the robot to the power supply device 200.

Next, in step S204, the power supply controller 203 of the power supply device 200 receives the above information from each of the robots 100A to 100D. The power supply controller 203 may perform processes subsequent to step S204, on the information received within a predetermined period. The predetermined period may be any period, but may be, for example, a time taken for the power supply device 200 to cross or go around the area where the power supply device 200 can supply power.

Next, the power supply controller 203 acquires the position information of the power supply device 200 from the storage unit 203h or the position detector 206 (step S205). Furthermore, the power supply controller 203 acquires distances LA to LD between the respective robots 100A to 100D and the power supply device 200 by using the position information of the respective robots 100A to 100D and the position information of the power supply device 200 (step S206). In this example, the distances LA to LD are linear distances, but may each be a distance along a route which is indicated by the map information and on which the power supply device 200 can travel. Next, the power supply controller 203 extracts the robot 100D having the shortest distance LD from among the distances LA to LD (step S207) and determines the robot 100D as a power supply target.

Next, the power supply controller 203 acquires the map information of the work place A where the power supply device 200 and the robots 100A to 100D are arranged, from the storage unit 203h (step S208). Moreover, the power supply controller 203 determines a travel route from the power supply device 200 to the robot 100D by using the position information of the robot 100D, the position information of the power supply device 200, and the map information (step S209).

Furthermore, the power supply controller 203 executes processes in steps S210 to S214 in the same manner as steps S107 to S111 of the first operation.

By executing the processes in steps S201 to S214, the power supply system 1 extracts the robot 100D located closest to the power supply device 200 from among the robots 100A to 100D which request power supply, and charges the power storage device 103 of the robot 100D. Therefore, the time taken for movement of the power supply device 200 is reduced, and efficient charging is enabled.

<Third Operation of Power Supply System 1>

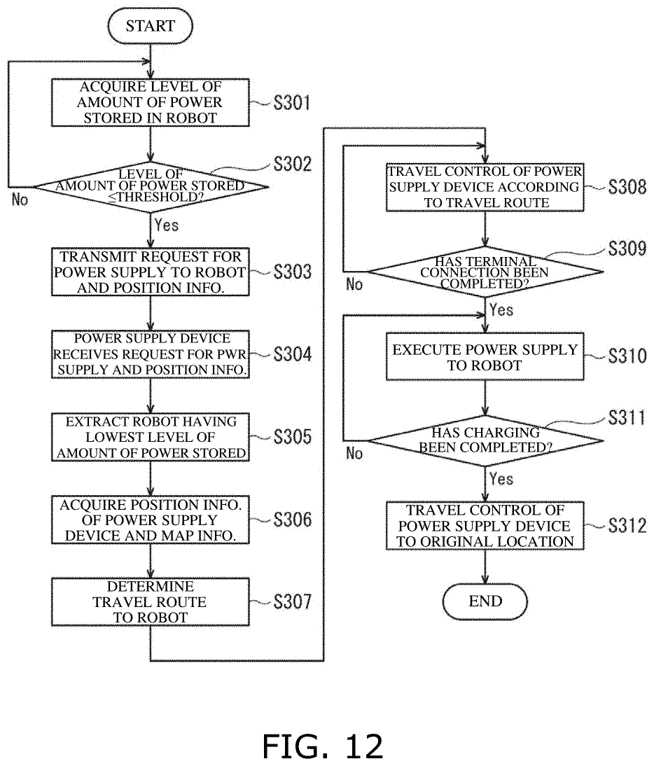

A third operation of the power supply system 1 according to the embodiment will be described. The third operation is another example of the operation of the power supply system 1 in case that robots 100 and one power supply device 200 exist in the work place of the robot 100. In the following, the third operation will be described for the example shown in FIG. 10. FIG. 12 is a flowchart showing an example of the third operation of the power supply system 1 according to the embodiment.

As shown in FIG. 10 and FIG. 12, the robot controller 105 of each of the robots 100A to 100D executes processes in steps S301 to S303 in the same manner as steps S201 to S203 of the second operation.

Next, in step S304, the power supply controller 203 of the power supply device 200 receives, from each of the robots 100A to 100D, the information about the amount of power stored including a request for power supply to the robot, and the position information of the robot. Moreover, the power supply controller 203 extracts the robot having the lowest level of the amount of power stored in the power storage device 103 among the robots 100A to 100D (step S305). In this example, the power supply controller 203 extracts the robot 100C whose SOC is a minimum value Csoc, and determines the robot 100C as a power supply target. The SOCs of the power storage devices 103 of the respective robots 100A to 100D are denoted by Asoc, Bsoc, Csoc, and Dsoc, and satisfy Asoc>Bsoc>Dsoc>Csoc.

Next, the power supply controller 203 acquires the position information of the power supply device 200 and the map information of the work place A from the storage unit 203h and/or the position detector 206 (step S306). Moreover, the power supply controller 203 determines a travel route from the power supply device 200 to the robot 100C by using the position information of the robot 100C, the position information of the power supply device 200, and the map information (step S307).

Furthermore, the power supply controller 203 executes processes in steps S308 to S312 in the same manner as steps S107 to S111 of the first operation.

By executing the processes in steps S301 to S312, the power supply system 1 extracts the robot 100C whose level of the amount of power stored in the power storage device 103 is the lowest, from among the robots 100A to 100D which request power supply, and charges the power storage device 103 of the robot 100C. Therefore, a situation in which the amount of power stored in the power storage device 103 becomes insufficient to make it impossible for the robots 100A to 100D to operate is prevented.

<Fourth Operation of Power Supply System 1>

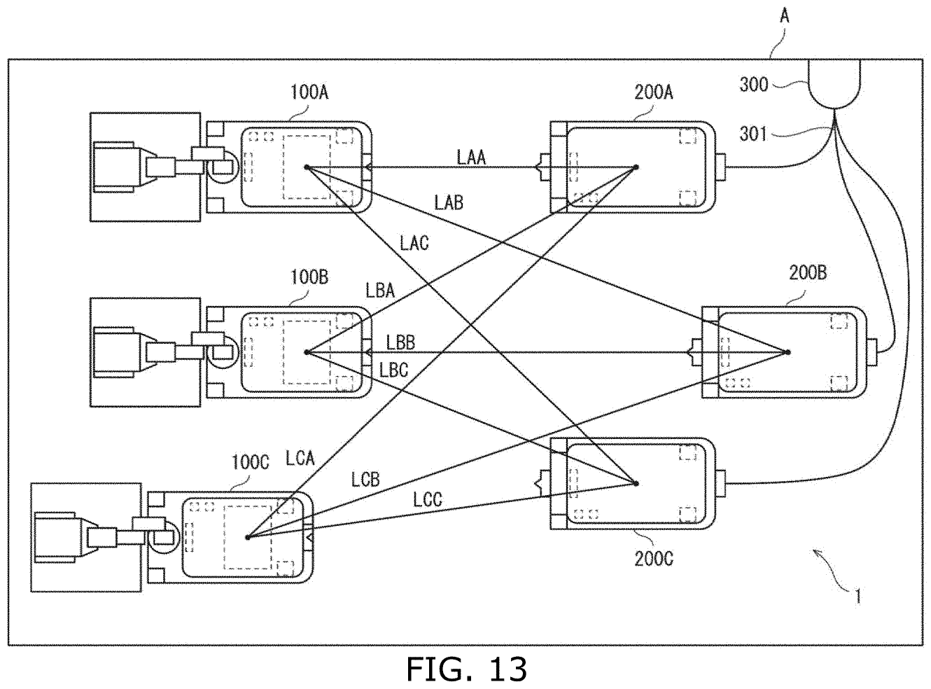

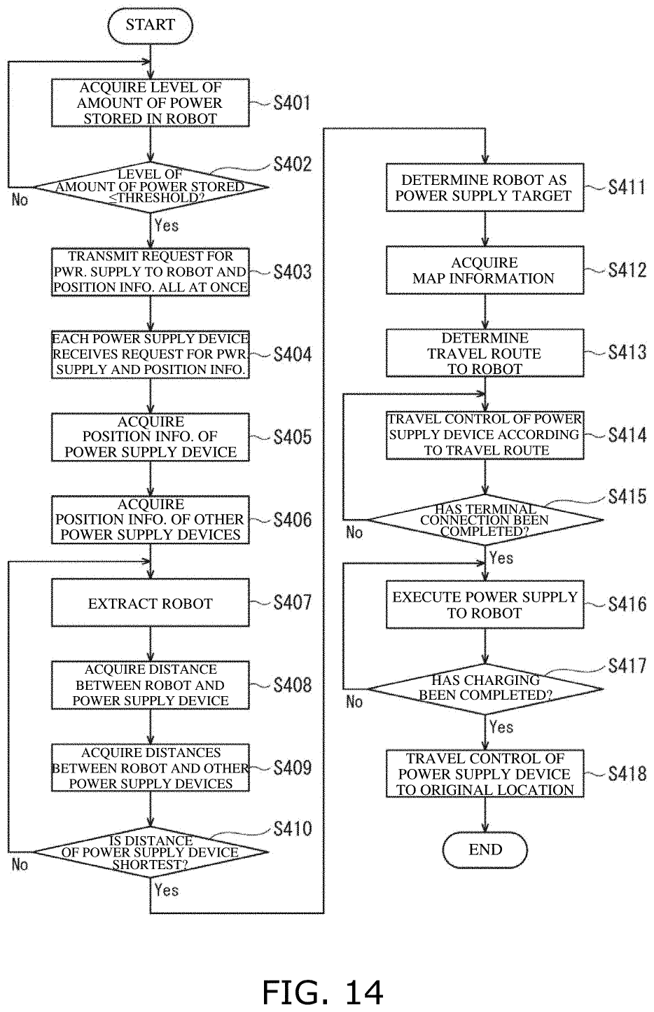

A fourth operation of the power supply system 1 according to the embodiment will be described. The fourth operation is an example of the operation of the power supply system 1 in case that robots 100 and power supply devices 200 exist in the work place of the robot 100. In the following, the fourth operation will be described for an example shown in FIG. 13. FIG. 13 is a plan view showing an example of arrangement of robots 100A to 100C and power supply devices 200 (hereinafter, also referred to as “power supply devices 200A to 200C”). FIG. 14 is a flowchart showing an example of the fourth operation of the power supply system 1 according to the embodiment.

As shown in FIG. 13 and FIG. 14, the robot controller 105 of each of the robots 100A to 100C executes processes in steps S401 to S403 in the same manner as steps S201 to S203 of the second operation. In step S403, each of the robots 100A to 100C transmits information on the amount of power stored including a request for power supply to the robot, and the position information of the robot to all the power supply devices 200A to 200C existing in the work place A, all at once. The following processes subsequent to step S404 are processes of one power supply device, and will be described with the power supply device 200A as an example.

Next, in step S404, the power supply controller 203 of the power supply device 200A receives the above information from each of the robots 100A to 100C. Moreover, the power supply controller 203 acquires the position information of the power supply device 200A from the storage unit 203h or the position detector 206 (step S405). Furthermore, the power supply controller 203 requests and acquires the position information of the other power supply devices 200B and 200C from the power supply devices 200B and 200C (step S406).

Next, the power supply controller 203 extracts one robot from among the robots 100A to 100C from which the information has been received in step S404 (step S407). For example, the robot 100A is extracted. Next, the power supply controller 203 acquires a distance LAA between the robot 100A and the power supply device 200A by using the position information of the robot 100A and the position information of the power supply device 200A (step S408). Moreover, the power supply controller 203 acquires distances LAB and LAC between the robot 100A and the other power supply devices 200B and 200C by using the position information of the robot 100A and the position information of the power supply devices 200B and 200C (step S409).

Next, the power supply controller 203 determines whether the distance LAA between the robot 100A and the power supply device 200A is the shortest among the distances LAA to LAC between the robot 100A and all the power supply devices 200A to 200C (step S410). If the distance LAA is the shortest (Yes in step S410), the power supply controller 203 proceeds to step S411. If the distance LAA is not the shortest (No in step S410), the power supply controller 203 returns to step S407. In step S407, the power supply controller 203 extracts one robot from the robots 100B and 100C which have not been extracted, and repeats the processes in steps S407 to S410.

In step S411, the power supply controller 203 determines the robot 100A extracted in step S407, as a power supply target. In this example, the distance LAA is the shortest among the distances LAA to LAC. As a result of repeating the processes in steps S407 to S410, if no robot having the shortest distance from the power supply device 200A is extracted, the power supply controller 203 may determine not to execute power supply to all the robots 100A to 100C from which the information has been received in step S404.

Next, the power supply controller 203 acquires the map information of the work place A where the power supply devices 200A to 200C and the robots 100A to 100C are arranged, from the storage unit 203h (step S412). Next, the power supply controller 203 determines a travel route from the power supply device 200A to the robot 100A by using the position information of the robot 100A, the position information of the power supply device 200A, and the map information (step S413).

Furthermore, the power supply controller 203 executes processes in steps S414 to S418 in the same manner as steps S107 to S111 of the first operation.

By executing the processes in steps S401 to S418, in the power supply system 1, the power supply device 200A charges the robot 100A having the shortest distance between the power supply device and the robot as compared to the other power supply devices 200B and 200C. Therefore, among all the power supply devices 200A to 200C, the power supply device located closest to the robot that requests power supply charges this robot, so that the moving distance of the power supply device is reduced and efficient charging is enabled.

<Effects, etc.>

The power supply system 1 according to the embodiment includes the robot 100 including the power storage device 103, the movable power supply device 200, and the power supply controller 203 as a controller. The power supply device 200 includes the terminal 201, as the first electrical connector, which is electrically connectable to the terminal 104 as the second electrical connector of the robot 100 and which is electrically connected to the power supply source 300 via a wire. The power supply controller 203 performs control for electrically connecting the terminal 201 and the terminal 104 and supplying power to the robot 100, on the basis of the information about the amount of power stored in the power storage device 103.

According to the above configuration, the power supply controller 203 can cause the power supply device 200 to supply power to the robot 100 via the terminal 201 in accordance with the information about the amount of power stored in the robot 100. Since the terminal 201 is electrically connected to the power supply source 300 via a wire, the power supply device 200 can stably supply sufficient power to the robot 100 without causing a shortage of power to be supplied. For example, the power supply device 200 can continuously supply power to robots 100. In addition, the robot 100 does not need to be connected to the power supply device 200 except when power is supplied thereto, and does not require a wired connection. Therefore, the restriction on the movement of the robot 100 is suppressed.

In the power supply system 1 according to the embodiment, the power supply device 200 may include the traveling device 202 which causes the power supply device 200 to travel, and may travel to the robot 100 by using the traveling device 202 in response to the control of the power supply controller 203. According to the above configuration, the power supply device 200 can autonomously travel to the robot 100 and supply power thereto. Therefore, automatic power supply to the robot 100 is enabled.

In the power supply system 1 according to the embodiment, the power supply device 200 may electrically connect the terminal 201 to the terminal 104 of the robot 100 in response to the control of the power supply controller 203. According to the above configuration, the power supply device 200 can autonomously connect the terminal 201 to the terminal 104 of the robot 100 and supply power thereto. Therefore, automatic power supply to the robot 100 is enabled.

In the power supply system 1 according to the embodiment, the power supply controller 203 may receive the information about the amount of power stored, from the robot 100 via wireless communication. According to the above configuration, no wired connection is needed for communication between the power supply controller 203 and the robot 100.

The power supply system 1 according to the embodiment may include at least one robot 100 and at least one power supply device 200. Moreover, the power supply controller 203 may determine at least either one of a robot 100 that is a power supply target or a power supply device 200 that is to perform power supply, on the basis of the information about the amount of power stored in at least one robot 100, the information on the position of at least one robot 100, and the information on the position of at least one power supply device 200. According to the above configuration, the power supply controller 203 determines a robot 100 that is a power supply target and a power supply device 200 that is to perform power supply, in consideration of the positional relationship between each robot 100 and each power supply device 200. Therefore, efficient and reliable power supply of the power supply device 200 is enabled.

The power supply system 1 according to the embodiment may include robots 100. Moreover, the power supply controller 203 may determine the robot 100 closest to the power supply device 200 among the robots 100 that need power supply, as a robot 100 that is a power supply target, on the basis of the information about the amounts of power stored in the robots 100, the information on the positions of the robots 100, and the information on the position of the power supply device 200. According to the above configuration, the moving distance of the power supply device 200 to the robot 100 that is the power supply target can be reduced. Therefore, efficient power supply of the power supply device 200 is enabled.

The power supply system 1 according to the embodiment may include power supply devices 200. Moreover, the power supply controller 203 may determine the power supply device 200 closest to the robot 100 that needs power supply, as a power supply device 200 that is to supply power to the robot 100, on the basis of the information about the amount of power stored in the robot 100, the information on the position of the robot 100, and the information on the positions of the power supply devices 200. According to the above configuration, the power supply device 200 located closest to the robot 100 supplies power to the robot 100. Therefore, efficient power supply of the power supply device 200 is enabled.

The power supply system 1 according to the embodiment may include robots 100. Moreover, the power supply controller 203 may determine the robot 100 having the lowest level of the amount of power stored therein among the robots 100 that need power supply, as a robot 100 that is a power supply target, on the basis of the information about the amounts of power stored in the robots 100. According to the above configuration, the power supply device 200 can supply power to the robot 100 that needs power supply most. Therefore, it is possible to prevent a situation in which the power of the power storage device 103 becomes insufficient, making it impossible for the robot 100 to operate.

In the power supply system 1 according to the embodiment, the power supply device 200 may include the power supply controller 203. According to the above configuration, the power supply device 200 can determine a robot 100 as a power supply target by itself and execute power supply to this robot 100. Therefore, execution of automatic power supply by the power supply device 200 alone is enabled.

The power supply device 200 according to the embodiment is a movable power supply device, and includes the terminal 201 which is electrically connectable to the terminal 104 of the robot 100 including the power storage device 103 and which is electrically connected to the power supply source 300 via a wire, and the power supply controller 203 which performs control for supplying power to the robot 100 via the terminal 201 on the basis of the information about the amount of power stored in the power storage device 103. According to the above configuration, the same effects as those of the power supply system 1 according to the embodiment are obtained.

<Modification 1>

A power supply system according to Modification 1 of the embodiment will be described. In a power supply system 11 according to Modification 1, the configuration of terminals 1041 and 2011 of a robot 1001 and a power supply device 2001 are different from those of the embodiment. Hereinafter, the present modification will be described focusing on the differences from the embodiment, and the same points as the embodiment are omitted.

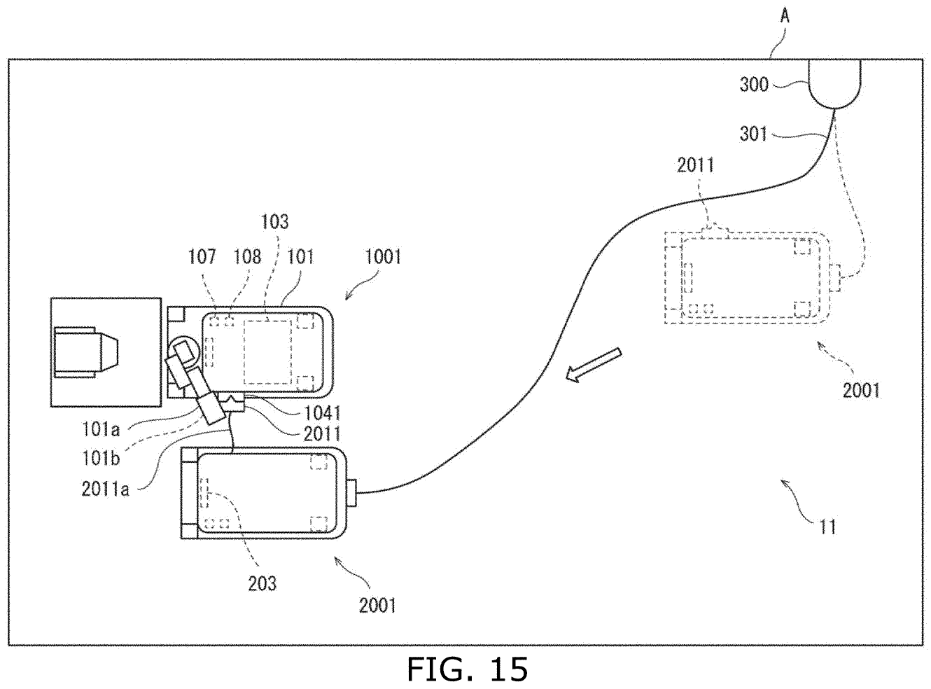

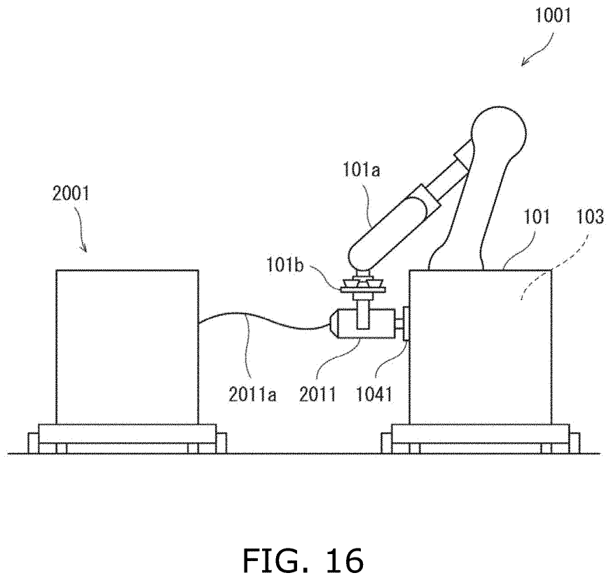

FIG. 15 is a plan view showing an example of the configuration of the power supply system 11 according to Modification 1. FIG. 16 is a side view showing an example of a connection state between the robot 1001 and the power supply device 2001 according to Modification 1. As shown in FIG. 15 and FIG. 16, the power supply device 2001 includes the terminal 2011 which is movable relative to the power supply device 2001. For example, the terminal 2011 is connected to a power line 2011a extending from the power supply device 2001, and is electrically connected to a power line 301 of a power supply source 300 via the power line 2011a. The terminal 2011 is movable within an area defined by the length of the power line 2011a. The robot 1001 includes the terminal 1041 within the reach of an arm 101a thereof.

Therefore, when the power supply device 2001 travels to the vicinity of the robot 1001 by itself, the robot controller 105 of the robot 1001 causes the arm 101a and a manipulator 101b to grasp and move the terminal 2011 of the power supply device 2001 to connect the terminal 2011 to the terminal 1041 of the robot 1001. The robot controller 105 may acquire the position of the terminal 2011 on the basis of the position information of the power supply device 2001. Accordingly, even when the power supply device 2001 is at various positions with respect to the robot 1001, it is possible to supply power from the power supply device 2001 to the robot 1001.

With the power supply system 11 according to Modification 1 as described above, the same effects as those of the embodiment are obtained. Moreover, in the power supply system 11, the robot 1001 may include the arm 101a which holds and moves the terminal 2011, and may electrically connect the terminal 2011 and the terminal 1041 by using the arm 101a. According to the above configuration, if the power supply device 2001 is located within the reach of the arm 101a, it is possible to connect the terminal 2011 and the terminal 1041. Therefore, the restrictions on the position and the orientation of the power supply device 2001 at the time of power supply are reduced, so that precise position control of the power supply device 2001 becomes unnecessary.

<Modification 2>

A power supply system according to Modification 2 of the embodiment will be described. In a power supply system 12 according to Modification 2, the configuration of a terminal 1042 of a robot 1002 is different from that of the embodiment. Hereinafter, the present modification will be described focusing on the differences from the embodiment and Modification 1, and the same points as the embodiment and Modification 1 are omitted.

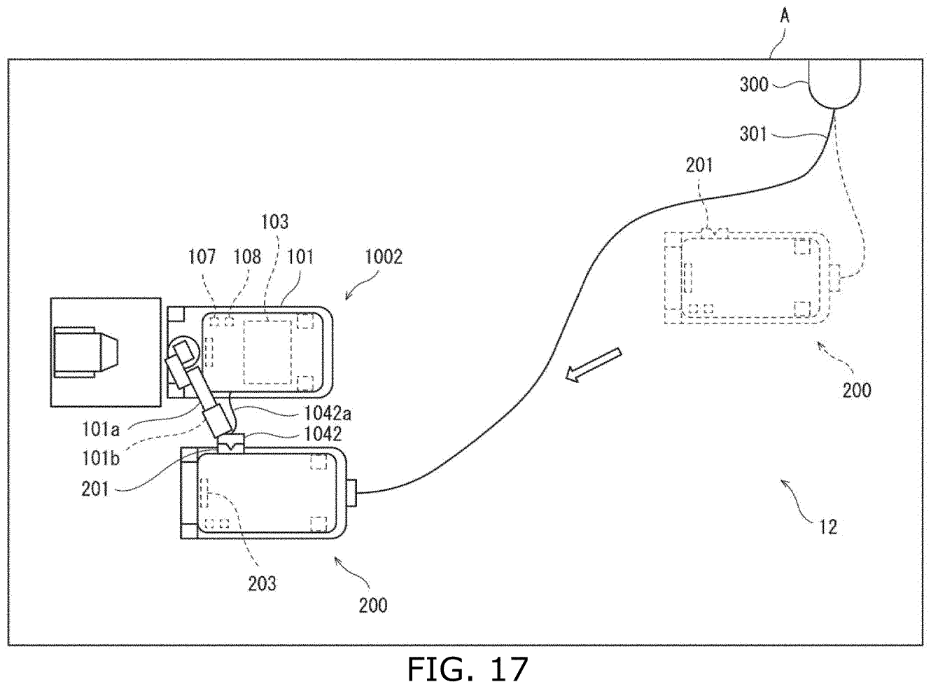

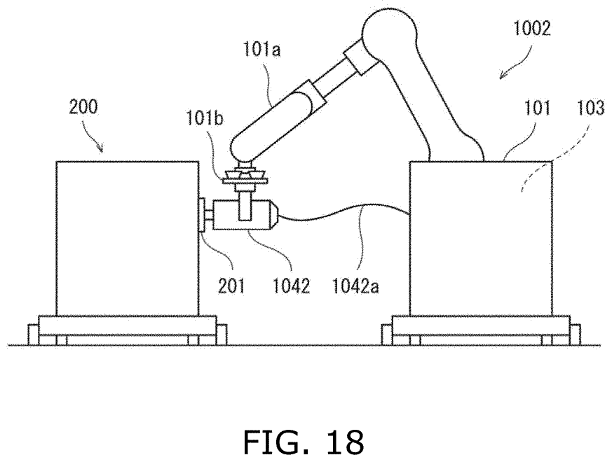

FIG. 17 is a plan view showing an example of the configuration of the power supply system 12 according to Modification 2. FIG. 18 is a side view showing an example of a connection state between the robot 1002 and a power supply device 200 according to Modification 2. As shown in FIG. 17 and FIG. 18, the robot 1002 includes a terminal 1042 which is movable relative to the robot 1002. The robot 1002 includes the terminal 1042 within the reach of an arm 101a thereof. For example, the terminal 1042 is connected to a power line 1042a extending from the robot 1002, and is electrically connected to a power storage device 103 or the like via the power line 1042a. The terminal 1042 is movable within an area defined by the length of the power line 1042a.

Therefore, when the power supply device 200 travels to the vicinity of the robot 1002 by itself, the robot controller 105 of the robot 1002 causes the arm 101a and a manipulator 101b to grasp and move the terminal 1042 to connect the terminal 1042 to the terminal 201 of the power supply device 200. The robot controller 105 may acquire the position of the terminal 201 on the basis of the position information of the power supply device 200. Accordingly, even when the power supply device 200 is at various positions with respect to the robot 1002, it is possible to supply power from the power supply device 200 to the robot 1002. With the power supply system 12 according to Modification 2 as described above, the same effects as those of Modification 1 are obtained. In the present modification, similar to Modification 1, the terminal 201 of the power supply device 200 may be movable relative to the power supply device 200.

<Modification 3>

A power supply system according to Modification 3 of the embodiment will be described. A power supply system 13 according to Modification 3 is different from that of the embodiment in including a management apparatus 500 which manages a robot 100 and a power supply device 2003. Hereinafter, the present modification will be described focusing on the differences from the embodiment and Modifications 1 and 2, and the same points as the embodiment and Modifications 1 and 2 are omitted.

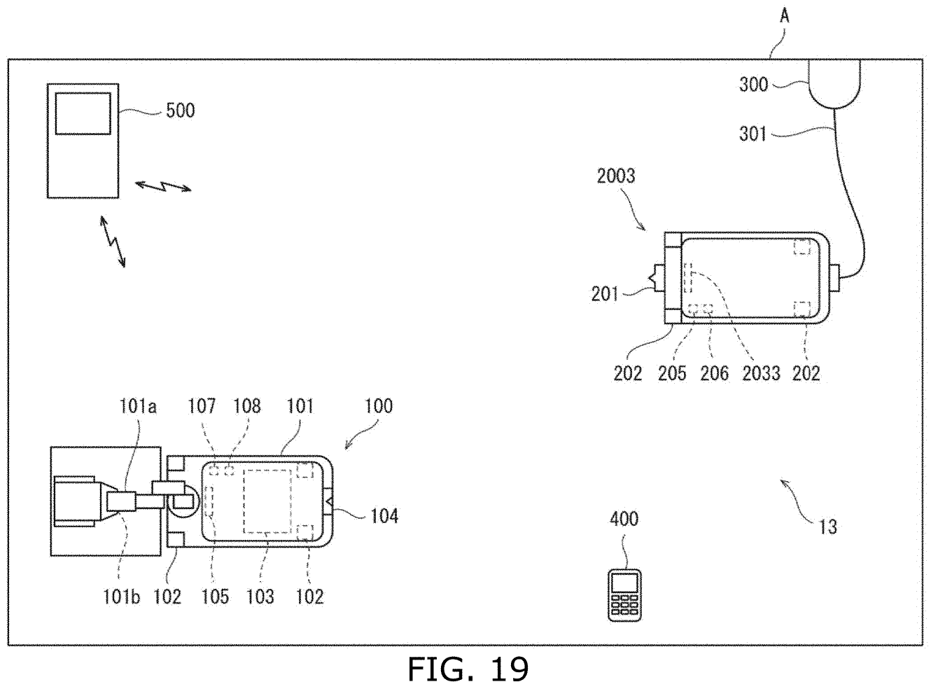

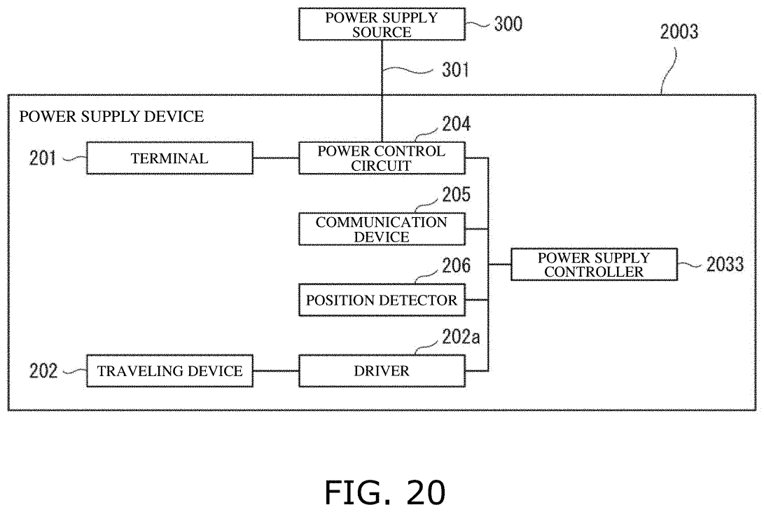

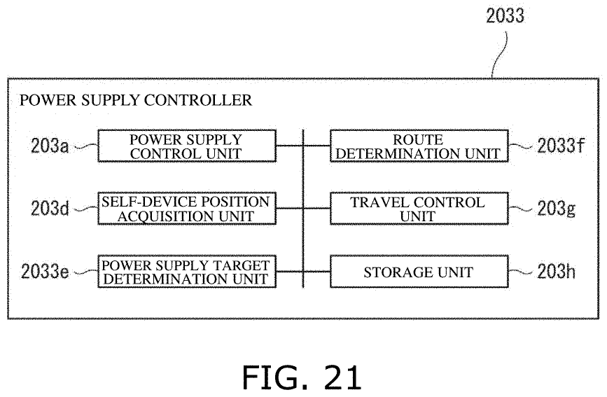

FIG. 19 is a plan view showing an example of the configuration of the power supply system 13 according to Modification 3. FIG. 20 is a block diagram showing an example of the configuration of the power supply device 2003 according to Modification 3. FIG. 21 is a block diagram showing an example of the functional configuration of a power supply controller 2033 of the power supply device 2003 according to Modification 3. As shown in FIG. 19, the power supply system 13 according to the present modification includes the robot 100, the power supply device 2003, and the management apparatus 500 which wirelessly communicate with each other. The management apparatus 500 manages one or more robots 100 and one or more power supply devices 2003. An example of the management apparatus 500 is a computer device.

As shown in FIG. 20, the power supply device 2003 includes the power supply controller 2033 instead of the power supply controller 203 according to the embodiment. As shown in FIG. 21, the power supply controller 2033 includes a power supply control unit 203a, a self-device position acquisition unit 203d, a power supply target determination unit 2033e, a route determination unit 2033f, a travel control unit 203g, and a storage unit 203h. The functions of the power supply control unit 203a, the self-device position acquisition unit 203d, the travel control unit 203g, and the storage unit 203h are the same as those of the embodiment.

The communication device 205 of the power supply device 2003 wirelessly communicates with the management apparatus 500, but may also wirelessly communicate with the robot 100 and another power supply device 2003. In addition, the self-device position acquisition unit 203d of the power supply controller 2033 transmits the position information of the power supply device 2003 to the management apparatus 500 via the communication device 205. However, as described below, the management apparatus 500 may detect the position of the power supply device 2003.

The power supply target determination unit 2033e receives information on the robot 100 determined as a power supply target by the management apparatus 500, from the management apparatus 500 via the communication device 205, and determines this robot 100 as a power supply target.

The route determination unit 2033f receives a travel route, from the power supply device 2003 to the robot 100 that is the power supply target, determined by the management apparatus 500, from the management apparatus 500 via the communication device 205, and determines this travel route as a travel route of the power supply device 2003.

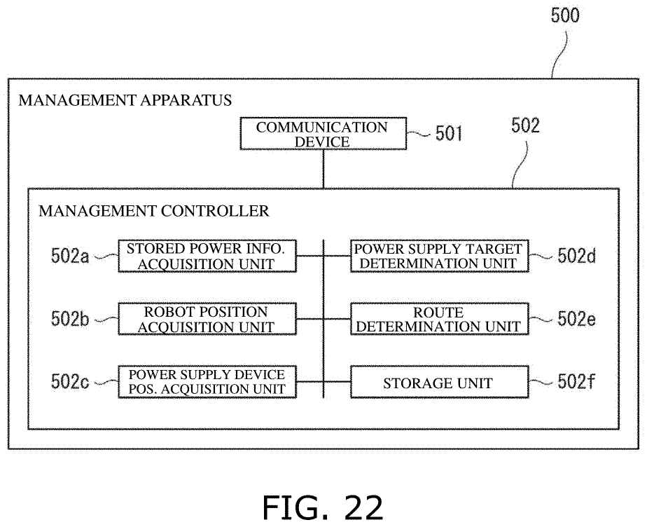

FIG. 22 is a block diagram showing an example of the configuration of the management apparatus 500 and the functional configuration of a management controller 502 according to Modification 3. As shown in FIG. 22, the management apparatus 500 includes a communication device 501 and the management controller 502. The communication device 501 includes a wireless communication circuit and communicates with the robot 100 and the power supply device 2003. For example, the communication device 501 receives information about the amount of power stored in the power storage device 103, and position information of the robot 100 from the robot 100, and receives position information of the power supply device 2003 from the power supply device 2003. In addition, the communication device 501 transmits a command for power supply to the robot 100 that is the power supply target and a travel route to the robot 100 that is the power supply target, to the power supply device 2003.

The management controller 502 includes a stored power information acquisition unit 502a, a robot position acquisition unit 502b, a power supply device position acquisition unit 502c, a power supply target determination unit 502d, a route determination unit 502e, and a storage unit 502f as functional components. Not all of these functional components are essential.

The storage unit 502f is realized by a storage device, such as a semiconductor memory such as a volatile memory and a non-volatile memory, a hard disk, and an SSD. Similar to the storage unit 203h, the storage unit 502f stores therein identification information of the robot 100, stored power information of the power storage device 103, position information of the robot 100, identification information of the power supply device 2003, position information of the power supply device 2003, map information, etc.

The functions of the components such as the stored power information acquisition unit 502a, the robot position acquisition unit 502b, the power supply device position acquisition unit 502c, the power supply target determination unit 502d, and the route determination unit 502e may be realized by a computer system which includes a processor, such as a CPU, a volatile memory, such as a RAM, a non-volatile memory, such as a ROM, etc. Some or all of the functions of the above components may be realized by the above computer system, may be realized by a dedicated hardware circuit, such as an electronic circuit or an integrated circuit, or may be realized by a combination of the above computer system and the above hardware circuit.

The stored power information acquisition unit 502a acquires the information about the amount of power stored in the power storage device 103, from the robot 100 via the communication device 501.

The robot position acquisition unit 502b acquires the identification information and the position information of the robot 100 from the robot 100 via the communication device 501. The robot position acquisition unit 502b may store the identification information and the position information of the robot 100 in the storage unit 502f in association with each other. The robot position acquisition unit 502b may detect the position of the robot 100. For example, the robot position acquisition unit 502b sends a signal to the robot 100, and when the robot controller 105 of the robot 100 receives the signal, the robot controller 105 returns the signal to the management apparatus 500. The robot position acquisition unit 502b can detect the position of the robot 100 with respect to the management apparatus 500 on the basis of the time for which the signal is sent back and forth between the management apparatus 500 and the robot 100, the direction in which the signal is received, and the like.

The power supply device position acquisition unit 502c acquires the identification information and the position information of the power supply device 2003 from the power supply device 2003 via the communication device 205. The power supply device position acquisition unit 502c may store the identification information and the position information of the power supply device 2003 in the storage unit 502f in association with each other. Similar to the robot position acquisition unit 502b, the power supply device position acquisition unit 502c may detect the position of the power supply device 2003.

Similar to the power supply target determination unit 203e according to the embodiment, the power supply target determination unit 502d determines whether power supply to the robot 100 is needed, on the basis of the information about the amount of power stored in the power storage device 103 of the robot 100. Moreover, the power supply target determination unit 502d determines a robot 100 that is a power supply target and a power supply device 2003 that is to supply power to the robot 100 that is the power supply target, on the basis of the information about the amount of power stored in the power storage device 103 of the robot 100 that needs power supply, the position information of the robot 100, the position information of the power supply device 2003, etc. The power supply target determination unit 502d transmits a command for power supply to the robot 100 determined as the power supply target, to the determined power supply device 2003.

Similar to the route determination unit 203f according to the embodiment, the route determination unit 502e determines a travel route for moving the power supply device 2003 determined by the power supply target determination unit 502d, to the robot 100 determined as the power supply target by the power supply target determination unit 502d. The route determination unit 502e transmits information on the determined travel route to the power supply device 2003.

As described above, the management apparatus 500 manages the level of the amount of power stored in the power storage device 103 of at least one robot 100, and the position of the robot 100, and manages the position of at least one power supply device 2003. Moreover, the management apparatus 500 determines a robot 100 that is a power supply target and a power supply device 2003 that is to supply power to the robot 100 that is the power supply target, and causes the power supply device 2003 to execute power supply. Such a management apparatus 500 has some of the functions of the power supply controller 203 according to the embodiment.

With the power supply system 13 according to Modification 3 as described above, the same effects as those of the embodiment are obtained. Moreover, in the power supply system 13, the management controller 502 as a controller may be arranged separately from the robot 100 and the power supply device 2003. According to the above configuration, the throughput of the robot controller 105 of the robot 100 and the power supply controller 2033 of the power supply device 2003 can be reduced. Therefore, it is possible to reduce the cost of the robot 100 and the power supply device 2003.

In the present modification, the management apparatus 500 causes the power supply device 2003 to execute power supply by transmitting a command and information to the power supply device 2003, but is not limited thereto. The management apparatus 500 may remotely control some or all of the functions of the power supply device 2003 via the communication device 501. The terminal device 400 may also serve as the management apparatus 500.

<Other Embodiments>

Although the examples of the embodiment of the present disclosure have been described above, the present disclosure is not limited to the above embodiment and modifications. That is, various modifications and improvements may be made within the scope of the present disclosure. For example, modes in which various modifications are applied to the embodiment and the modifications and modes constructed by combining the components in different embodiments and modifications are also included within the scope of the present disclosure.

For example, in the embodiment and the modifications, the power supply device, the robot, and the management apparatus are configured to wirelessly communicate with each other, but are not limited thereto. For example, the power supply device, the robot, and the management apparatus may be configured to output light, sound, or a combination thereof and receive them. Light, sound, and a combination thereof can indicate information about the amount of power stored in the power storage device, the position information of each device, etc.

In the embodiment and the modifications, the power supply device is configured to travel to the robot by itself, but is not limited thereto. For example, the power supply device or the terminal thereof may be moved to the robot by a person and the terminal may be connected to the terminal of the robot. In this case, the power supply device may include a display device, and the display device may indicate the robot that is a power supply target. Alternatively, the robot may output light, sound, or a combination thereof, and a person may identify the robot that is a power supply target, by perceiving these.

In the modifications, the robot main body 101 is configured to connect the terminal by using the arm 101a and the manipulator 101b, but is not limited thereto. For example, the power supply device may include a device which can connect the terminal such as the robot main body 101, and may connect the terminal by using this device. Alternatively, the above device of the power supply device and the robot main body 101 may cooperate to connect the terminal.

In the embodiment and the modifications, the power supply device and the robot are configured to connect the terminals thereof to each other, but are not limited thereto. For example, the power supply device and the robot may simply bring the terminals thereof into contact with each other. Alternatively, the power supply device and the robot may be configured to be electrically connected to each other, for example, by contacting, engaging, or fitting conductive members thereof with each other. Still alternatively, the power supply device and the robot may include wireless power transfer devices, and may be configured such that the power supply device supplies power to the robot in a non-contact manner when the power supply device and the robot come close to each other.

In the embodiment and the modifications, the power supply device and the robot are configured to acquire their own positions by using the GPS and/or IMU, but are not limited thereto. For example, the power supply device and the robot may acquire the positions of the power supply device and the robot by detecting the magnetic field of a magnet embedded in a floor surface. Alternatively, the positions of the power supply device and the robot may be detected by analyzing images of the power supply device and the robot captured by a camera. Still alternatively, distance measuring sensors, such as a laser sensor, a laser lidar, and an ultrasonic sensor, may be provided, and the positions of the power supply device and the robot may be detected using the measured values thereof.

In the embodiment and the modifications, the robot main body 101 is configured as a vertical articulated robot, but is not limited thereto. For example, the robot main body 101 may be configured as a horizontal articulated robot, a polar coordinate robot, a cylindrical coordinate robot, a Cartesian coordinate robot, a vertical articulated robot, or another robot. The robot main body 101 includes one arm 101a, but may include two or more arms 101a.

### REFERENCE SIGNS LIST

1, 11, 12, 13 power supply system

100, 100A to 100D, 1001, 1002 robot

103 power storage device

104, 1041, 1042 terminal (second electrical connector)

200, 200A to 200C, 2001, 2003 power supply device

201, 2011 terminal (first electrical connector)

202 traveling device

203, 2033 power supply controller (controller)

300 power supply source

500 management apparatus

502 management controller (controller)

1. A power supply system comprising:
a robot including a power store;
a movable power supply; and
a controller, wherein
the power supply includes a first electrical connector that is electrically connectable to a second electrical connector of the robot and that is electrically connected to a power supply source via a wire, and
the controller performs control for electrically connecting the first electrical connector and the second electrical connector and supplying power to the robot, on the basis of information about an amount of power stored in the power store.

2. The power supply system according to claim 1, wherein the power supply further includes a traveler that causes the power supply to travel, and travels to the robot by using the traveler in response to control of the controller.

3. The power supply system according to claim 2, wherein the power supply travels in response to the control of the controller and electrically connects the first electrical connector to the second electrical connector of the robot.

4. The power supply system according to claim 1, wherein the robot includes an arm that holds and moves at least either one of the first electrical connector or the second electrical connector, and electrically connects the first electrical connector and the second electrical connector by using the arm.

5. The power supply system according to claim 1, wherein the controller receives the information on the amount of power stored, from the robot via wireless communication.

6. The power supply system according to claim 1, wherein
the power supply system includes at least the one robot and at least the one power supply, and
the controller determines at least either one of the robot that is a power supply target or the power supply that is to perform power supply, on the basis of the information about the amount of power stored in said at least one robot, information on a position of said at least one robot, and information on a position of said at least one power supply.

7. The power supply system according to claim 6, wherein
the power supply system includes the robots, and
the controller determines the robot closest to the power supply among the robots that need power supply, as the robot that is a power supply target, on the basis of the information about the amounts of power stored in the robots, information on positions of the robots, and information on a position of the power supply.

8. The power supply system according to claim 6, wherein
the power supply system includes the power supplies, and
the controller determines the power supply closest to the robot that needs power supply, as the power supply that is to supply power to the robot, on the basis of the information about the amount of power stored in the robot, information on a position of the robot, and information on positions of the power supplies.

9. The power supply system according to claim 1, wherein
the power supply system includes the robots, and
the controller determines the robot having a lowest level of the amount of power stored among the robots that need power supply, as the robot that is a power supply target, on the basis of the information about the amounts of power stored in the robots.

10. The power supply system according to claim 1, wherein the controller is arranged separately from the robot and the power supply.

11. The power supply system according to claim 1, wherein the power supply further includes the controller.

12. A movable power supply device comprising:
a first electrical connector that is electrically connectable to a second electrical connector of a robot including a power store and that is electrically connected to a power supply source via a wire; and
a controller that performs control for supplying power to the robot via the first electrical connector, on the basis of information about an amount of power stored in the power store.

13. The power supply system according to claim 7, wherein
the power supply system includes the power supplies, and
the controller determines the power supply closest to the robot that needs power supply, as the power supply that is to supply power to the robot, on the basis of the information about the amount of power stored in the robot, information on a position of the robot, and information on positions of the power supplies.

14. The power supply system according to claim 6, wherein
the power supply system includes the robots, and
the controller determines the robot having a lowest level of the amount of power stored among the robots that need power supply, as the robot that is a power supply target, on the basis of the information about the amounts of power stored in the robots.

15. The power supply system according to claim 7, wherein
the power supply system includes the robots, and
the controller determines the robot having a lowest level of the amount of power stored among the robots that need power supply, as the robot that is a power supply target, on the basis of the information about the amounts of power stored in the robots.

16. The power supply system according to claim 8, wherein
the power supply system includes the robots, and
the controller determines the robot having a lowest level of the amount of power stored among the robots that need power supply, as the robot that is a power supply target, on the basis of the information about the amounts of power stored in the robots.

17. The power supply system according to claim 13, wherein
the power supply system includes the robots, and
the controller determines the robot having a lowest level of the amount of power stored among the robots that need power supply, as the robot that is a power supply target, on the basis of the information about the amounts of power stored in the robots.
